(19) United States
(12) Patent Application Publication
(10) Pub. No.: US 2017/0088249 A1
(43) Pub. Date: Mar. 30, 2017

(54) COMPOSITE RIB FOR A TORSION BOX AND MANUFACTURING METHOD THEREOF

(71) Applicant: AIRBUS OPERATIONS, S.L., GETAFE (Madrid) (ES)

(72) Inventors: Carlos GARCÍA NIETO, Getafe (Madrid) (ES); Iker VELEZ DE MENDIZABAL ALONSO, Getafe (Madrid) (ES); Enrique GUINALDO FERNANDEZ, Getafe (Madrid) (ES); Soledad CRESPO PEÑA, Getafe (Madrid) (ES)

(21) Appl. No.: 15/279,586

(22) Filed: Sep. 29, 2016

(30) Foreign Application Priority Data
Sep. 29, 2015 (EP) 15382472.7

(51) Int. Cl. B64C 3/18; B29C 70/48; B64F 5/00

(52) U.S. Cl. CPC B64C 3/187; B64F 5/0009; B29C 70/48; B29K 2105/0872

(57) ABSTRACT

The present disclosure refers to the configuration and manufacturing process of a rib for the construction of an aircraft torsion box. In the method, a flat stack of plies of composite material is layered up, which is then cut to form a flat pre-form having an outer contour having flanges, and an internal contour having two or more diagonal trusses with flanges at opposite sides. The flat pre-form is press-formed to fold the flanges of the outer and internal contour to form a rib pre-form, which is finally cured. The present disclosure also refers to a composite rib having a unitary body by forming a single pre-form of stacked plies. The present disclosure allows the manufacture of the rib in one-shot process, integrating all the ribs components such that the assembly time and cost of the rib are minimized.

### CROSS-REFERENCE TO RELATED APPLICATIONS

The present disclosure claims priority to European Application No. 15382472.7 filed on Sep. 29, 2015, which is hereby incorporated by reference, as though set forth fully herein.

### FIELD OF DISCLOSURE

The present disclosure refers to the configuration and manufacturing process of a rib for the construction of a torsion box for an aircraft wings, vertical tail planes (VTP) or horizontal tail planes (HTP).

An object of the present disclosure is to provide a torsion box rib which can be obtained as an unitary body integrating all of the rib components, such that weight, assembly time, and cost of the rib are minimized.

Another object of the present disclosure is a manufacturing process based on composite material, which allows the manufacture of torsion ribs in one-shot process, that is, with only one curing cycle.

### BACKGROUND OF THE DISCLOSURE

Typically, a multi-rib torsion box is formed by front and rear spars and a plurality of ribs transversally arranged and fitted to the front and rear spars, such as to form a box-like configuration. Other components for example of a HTP, like leading and trailing edges, and upper and lower skin panels internally reinforced by stringers are fitted to the torsion box. Commonly, all these components are manufactured with composite materials, such as Carbon Fiber Reinforced Plastic (CFRP).

The main functions of the ribs are: providing torsional stiffness, longitudinally limiting the skins and the stringers so as to discretize buckling loads, maintaining the shape of the aerodynamic surface, and supporting local load introductions resulting from actuator fittings, support bearings and similar devices, which are directly secured to the front and rear spars.

Typical configurations for torsion boxes ribs are: C-shaped ribs, L-shaped ribs, Flat web ribs, Double C-shaped ribs, and Truss ribs.

FIGS. 1A and 1B show various views of a C-shaped rib according to the prior art, wherein FIG. 1A is a cross-sectional view of the C-shaped rib, and FIG. 1B is a perspective view of the C-shaped rib. The C-shaped rib (1) consists of a C-section one piece rib having a web (2) and flanges (3) both in its upper and lower edges. The C-shaped rib (1) is joined to the skins through the flanges (3), and is joined to spars by additional components such as brackets (not shown). The rib (1) is provided with a plurality of “mouse” holes (5) to receive the stringers of the upper and lower covers.

FIGS. 2A and 2B show various views of a L-shaped rib according to the prior art, wherein FIG. 2A is perspective view of the L-shaped rib, and FIG. 2B is a perspective view of the L-shaped rib with brackets. The L-shaped rib consist of an L-section one piece rib having a web (2) and flanges (3) only in one of its upper and lower edges. The L-shaped rib is joined to one skin through its flange (3), and is fixed to the other skin using brackets (4). The rib is joined to the spars also with brackets.

FIGS. 3A, 3B, and 3C show various views of a flat web rib according to the prior art, wherein FIG. 3A is a perspective view of the flat web rib with angles or T-profiles, FIG. 3B is a perspective view of the flat web rib, and FIG. 3C is a perspective view of the flat web rib with brackets. The flat web rib consists of a flat web (2) without flanges. The rib is fixed to the skins by angles or T-profiles, or via continuous flanges (6) (so called formers). The rib (1) is joined to the spars via brackets (5).

FIG. 4 shows a perspective view of a double C-shaped rib according to the prior art. The double C-shaped rib is obtained by coupling web to web two C-shaped sections (1,1′) together. The attachment of this type of rib to the skins is carried out by the integrated flanges (3,3′). The rib is joined to the spars via brackets (not shown).

FIG. 5 shows a perspective view of a truss rib according to the prior art. The truss rib includes an upper former and a lower former (7,7′), and several diagonal struts (8) and front and rear T-shaped profiles (9,9′), joining the formers by mechanical joints (typically bolted or riveted). The struts are made of CFRP, and the formers are CFRP or metallic. It can be noted, in FIG. 5, the complexity of this type of rib requires a large number of fastened joints.

Additionally, different rib web configurations such as multi-stiffened flat webs, or hole-lightened webs, can be used any of the previously described ribs of FIGS. 1A to 5.

FIG. 6 shows a perspective view of a multi-stiffened web L-Shaped rib according to the prior art. The multi-stiffened web L-Shaped rib configuration consists of a web (2) reinforced with vertical stiffeners (10) on the rib's flat surface. The web (3) allows for a variable thickness sizing, and the stiffeners are manufactured separately and then bonded or riveted to the web (2).

FIGS. 7A and 7B show a hole-lightened rib configuration according to the prior art, where FIG. 7A shows the hole-lightened rib configuration without stiffeners, and FIG. 7B shows the hole-lighted rib configuration rib with stiffeners. The hole-lightened rib web configuration consists of a web (2) with joggled flanged lightening holes (11). The flat web can be reinforced if necessary with vertical stiffeners (10) (FIG. 7B) between each two holes. This configuration allows also different web thicknesses between each two stiffeners.

As it can be noted, the classical configurations of prior art ribs include different components that have to be manufactured separately and then assembled together. As a result, current manufacturing process are time consuming and expensive.

### SUMMARY OF THE DISCLOSURE

The present disclosure is defined in the attached independent claims, and overcomes the above-mentioned drawbacks of the prior art, by providing a torsion box rib design which allows a manufacturing process as an unitary body integrating all of the rib elements, such as lattice structure and flanges, and can be manufactured from a single CFRP pre-form in one-shot.

Therefore, an aspect of the present disclosure refers to a composite rib obtained as a unitary body by conforming a single pre-form of stacked plies. The rib includes an outer frame having a substantially rectangular configuration with an outer frame contour and an internal frame contour. The outer frame contour has one or more flanges such that the rib has one of a C-shaped, an I-shaped, or flat cross-sectional shape.

Preferably, the rib includes a plurality of diagonal trusses forming a zigzag pattern within an area defined by the internal frame contour. The rib further includes one or more flanges located at opposite sides of the trusses, and the flanges are at the internal frame contour.

The rib of the present disclosure can be manufactured in one-shot (only one curing cycle) as a unitary piece, integrating all the elements of the rib such that the trusses, rib feet and spars interface flanges, and truss stabilization flanges are all part of the same unitary piece.

Unlike the prior art, all of the elements of the rib of the present disclosure are formed in the same manufacturing process, such that the manufacture and assembly of ancillary components is avoided. Also, there is no need to provide brackets or similar components for fixing the rib to the spars and stringers of a torsion box.

Another aspect of the present disclosure refers to a method for manufacturing a composite rib for a torsion box. First, a flat stack of plies is formed, by laying up a plurality of plies of composite material on a flat surface. The flat stack of plies is then cut to form a flat pre-form with a predefined configuration, which includes an outer contour with a battlement pattern defining flanges.

During the cutting process, an internal contour is also formed within an area defined by the outer contour, such that the internal contour has two or more diagonal trusses in the form of strips, and one or more flanges located at opposite sides of each truss.

At that stage, the flanges of the outer and internal contours are flat and co-planar with the rest of the pre-form. At a subsequent process step, the flat pre-form is press-formed to fold the flanges of the outer and internal contours to form a rib pre-form.

Finally, the composite rib piece is cured and trimmed as a separate piece, and then co-bonded or riveted to other components of a torsion box. Alternatively, the composite rib is co-cured with other components of a torsion box.

### BRIEF DESCRIPTION OF THE FIGURES

Preferred aspects of the present disclosure are henceforth described with reference to the accompanying drawings, wherein:

FIGS. 1A and 1B show various views of a C-shaped rib according to the prior art, wherein FIG. 1A is a cross-sectional view of the C-shaped rib, and FIG. 1B is a perspective view of the C-shaped rib;

FIGS. 2A and 2B show various views of a L-shaped rib according to the prior art, wherein FIG. 2A is perspective view of the L-shaped rib, and FIG. 2B is a perspective view of the L-shaped rib with brackets;

FIGS. 3A, 3B, and 3C show various views of a flat web rib according to the prior art, wherein FIG. 3A is a perspective view of the flat web rib with angles or T-profiles, FIG. 3B is a perspective view of the flat web rib, and FIG. 3C is a perspective view of the flat web rib with brackets;

FIG. 4 shows a perspective view of a double C-shaped rib according to the prior art;

FIG. 5 shows a perspective view of a truss rib according to the prior art;

FIG. 6 shows a perspective view of a multi-stiffened web L-Shaped rib according to the prior art;

FIGS. 7A and 7B show a hole-lightened rib configuration according to the prior art, wherein FIG. 7A shows the hole-lightened rib configuration without stiffeners, and FIG. 7B shows the hole-lighted rib configuration rib with stiffeners;

FIGS. 8A and 8B each show different angles of a perspective view of a torsion box rib in accordance with an aspect of the present disclosure and which is obtained by the method or process shown in FIGS. 9A-9E, wherein the profile of the torsion box rib can be C-shaped or I-shaped through the use of two symmetrical pre-forms;

FIGS. 9A-9E are schematic illustrations of a torsion box rib manufacturing process in accordance with an aspect of the present disclosure, with FIGS. 9A-9E shown in a sequential order from top to bottom, wherein FIG. 9A illustrates a composite plies flat lay-up, FIG. 9B illustrates the composite plies flat with pre-form cutting, FIG. 9C illustrates the composite plies flat with pre-form press-forming where folding movements of the flanges are designated by the arrows, FIG. 9D illustrates the composite plies flat in the curing and trimming final process, and FIG. 9E illustrates a terminated rib; and

FIGS. 10A-10C show another example of a torsion rib box in accordance with an aspect of the present disclosure, wherein FIG. 10A is top plan view of a composite plies flat with pre-form cutting where broken lines indicate the areas that will be folded during the press-forming process to form continuous flanges, FIG. 10B is a front elevational view of the conformed pre-form of FIG. 10A, and FIG. 10C is a perspective view of the same rib.

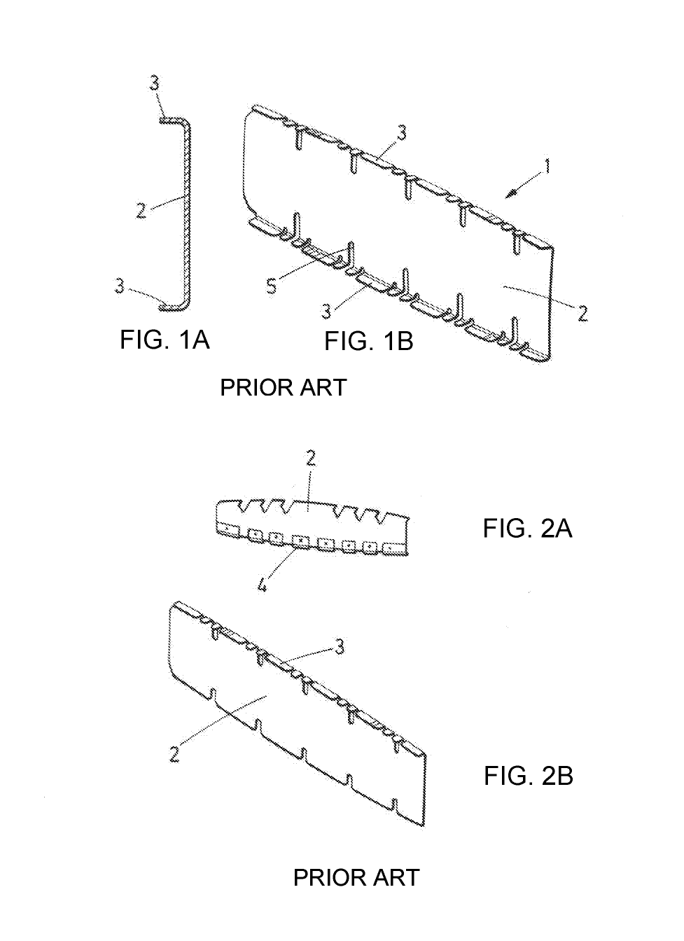

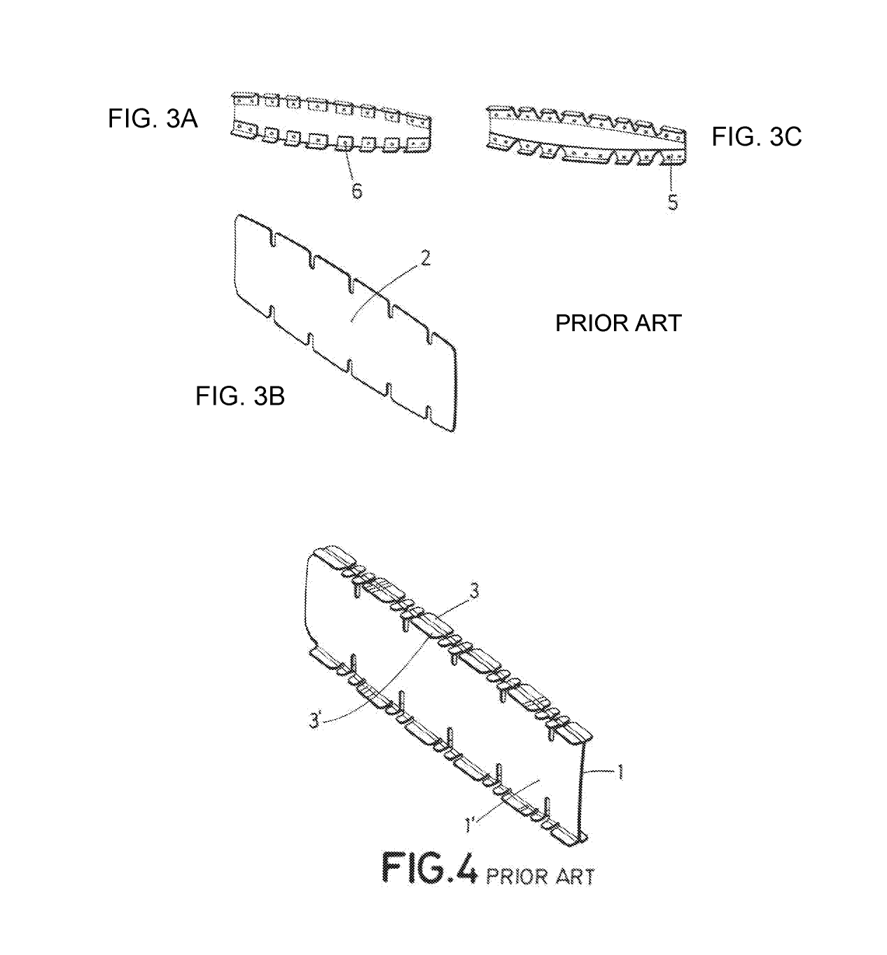

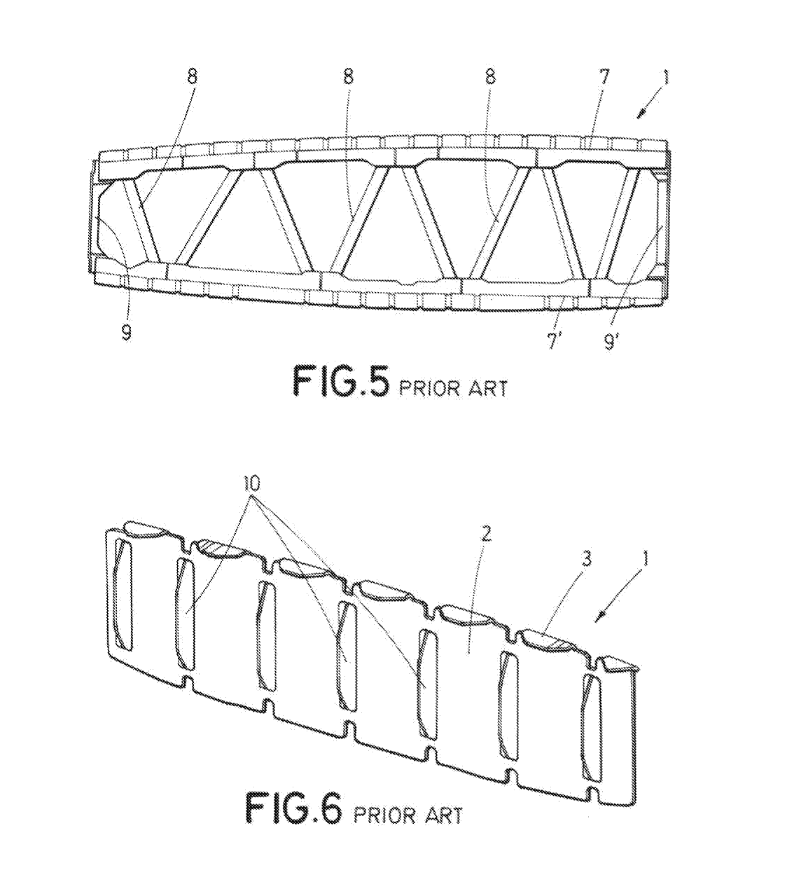

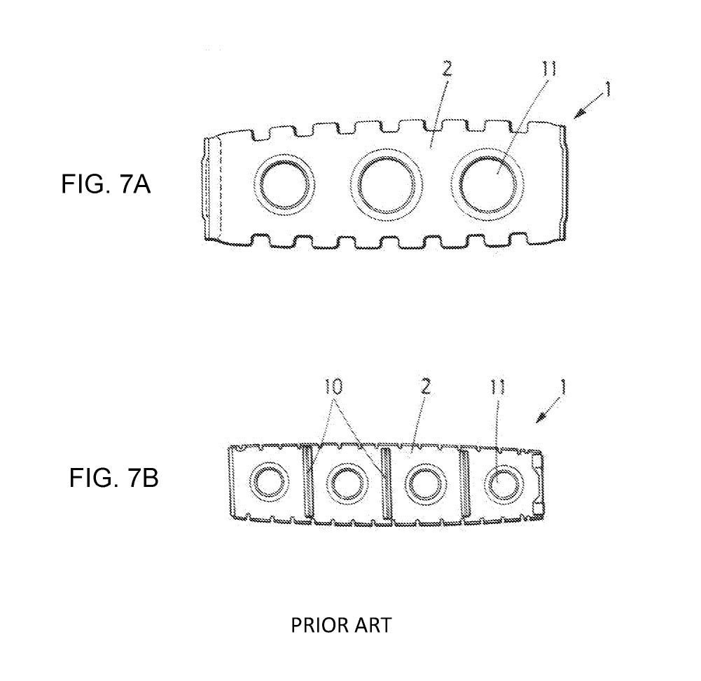

### DETAILED DESCRIPTION OF THE PRESENT DISCLOSURE

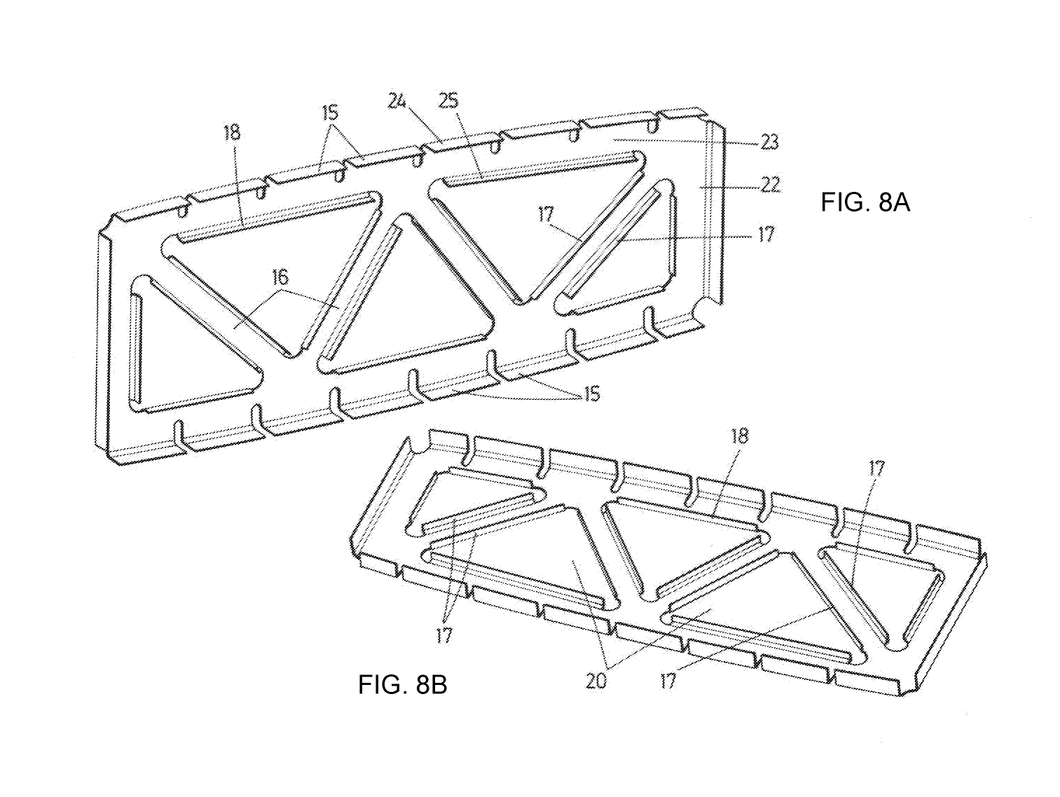

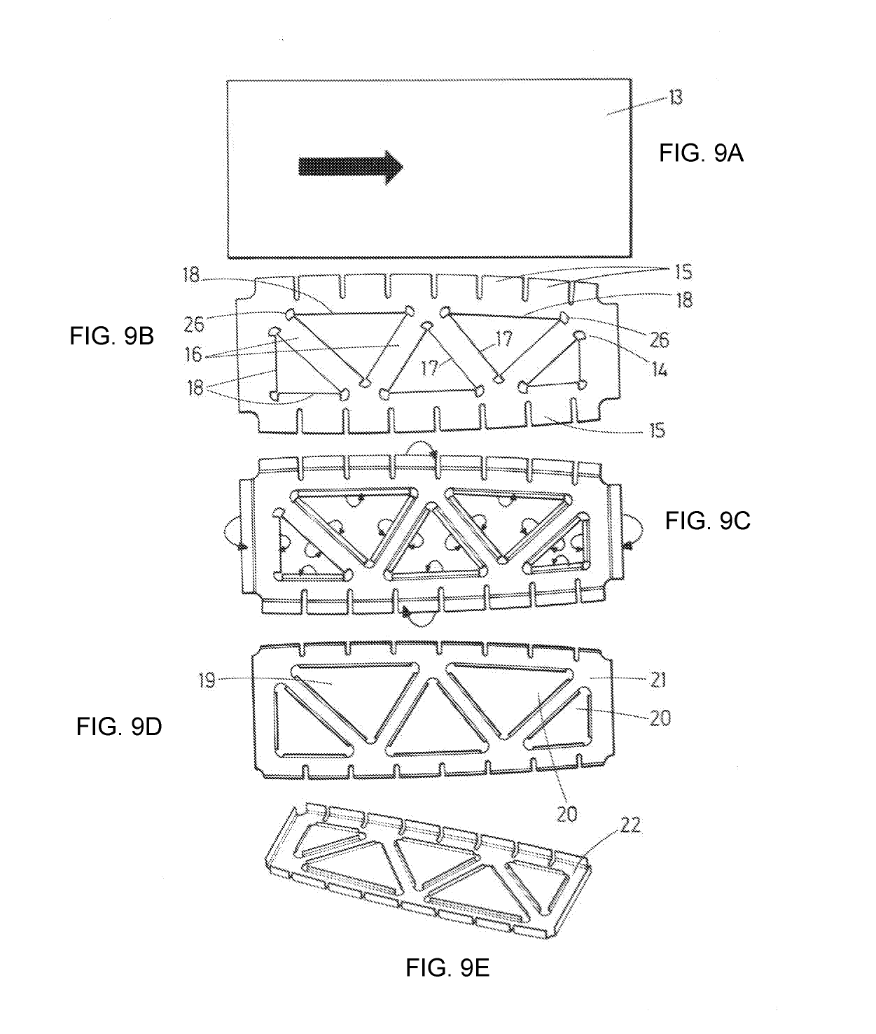

FIGS. 8A and 8B each show different angles of a perspective view of a torsion box rib in accordance with an aspect of the present disclosure and which is obtained by the method or process shown in FIGS. 9A-9E, where the profile of the torsion box rib can be C-shaped or I-shaped through the use of two symmetrical pre-forms. In a preferred aspect of the present disclosure a composite rib (22) for a torsion box is obtained as an unitary body by conforming a single pre-form of stacked plies (14), according the manufacturing method of the present disclosure discussed in further detail below.

The rib (22) of FIGS. 8A and 8B have an outer frame (23) of a substantially rectangular configuration with an outer frame contour (24) and an internal frame contour (25). The outer frame contour (24) has a plurality of flanges (15) such that the rib has a C-shaped cross-sectional shape. The rib (22) further includes a plurality of diagonal trusses (16) forming a zigzag pattern within an area defined by the internal frame contour (25), and one or more flanges (17) are formed at opposite sides of the truss (16), and one or more flanges (18) are formed at the internal frame contour (25).

This rib configuration integrates all of the ribs elements, such that the rib can be assembled directly in a torsion box being constructed, without brackets or any other ancillary elements. The rib (22) can be co-cured with the torsion box components (if all components are pre-preg), or co-bonded (in a hard/wet pre-preg preparation or in RTM/wet pre-preg). The rib could also be assembled by traditional means such as riveting.

In other preferred aspects of the present disclosure, the rib may have one of a flat profile, or an I-shaped cross-sectional shape, and may be configured with holes instead of trusses.

FIGS. 9A-9E illustrates a sequence of steps of the manufacturing method according to an aspect of the present disclosure. First, several plies of composite material (preferably CFRP) are layered up on a flat surface, for example by an ATL machine, to form a substantially flat stack of plies (13) (FIG. 9A). The thickness of the stack of plies (13) does not need to be constant, but thickness transitions can be formed during the lay-up.

At a subsequent manufacturing step (FIG. 9B), some areas of the flat stack of plies (13) are cut out from the stack of plies (13) to form a flat pre-form (14) having an outer contour (15) having a battlement pattern with flat flanges (15), and an internal contour within the area defined by the outer contour, the internal contour has two or more diagonal trusses (16), and flat flanges (17) at opposite sides of the trusses (16). Additional flanges (18) are formed in this flat pre-form (14) at the internal frame contour (25).

In the preferred aspect of the present disclosure, for conforming the flat flanges (17), some cut-outs (26) are formed at the corners between two consecutive trusses (16), such that the flat flanges (17) are obtained as individual straight segments and can be easily folded at a subsequent step.

The flat pre-form (14) is then press-formed (FIG. 9C) to fold all the flanges of the outer and internal contours (15, 17, and 18) to form a rib pre-form (21) (FIG. 9D).

The rib pre-form (21) is then cured and trimmed, such a finished rib (22) (FIG. 9E) is obtained in only one curing cycle and as a unitary body integrating all the elements of the rib (frame, flanges, truss, etc.), such that the rib can be attached directly to other elements of a torsion box, such as skin covers stringers and front and rear spars.

The external contour is generally rectangular having two large opposing sides and two short opposing sides. As illustrated in FIG. 9C, the flanges (15, 17, and 18) are folded toward the same side of the rib, until the flanges (15, 17, 1 and 8) are placed at an orthogonal position with respect to the plane defined by the rib, such that the rib has a C-shaped cross-sectional shape.

As it can be noted in FIGS. 9A-9E, the internal contour has a plurality of diagonal trusses (16) forming a zigzag pattern (19), and triangular openings (20) in the flat pre-form (14) with flanges (18) at the sides of each triangular opening (20).

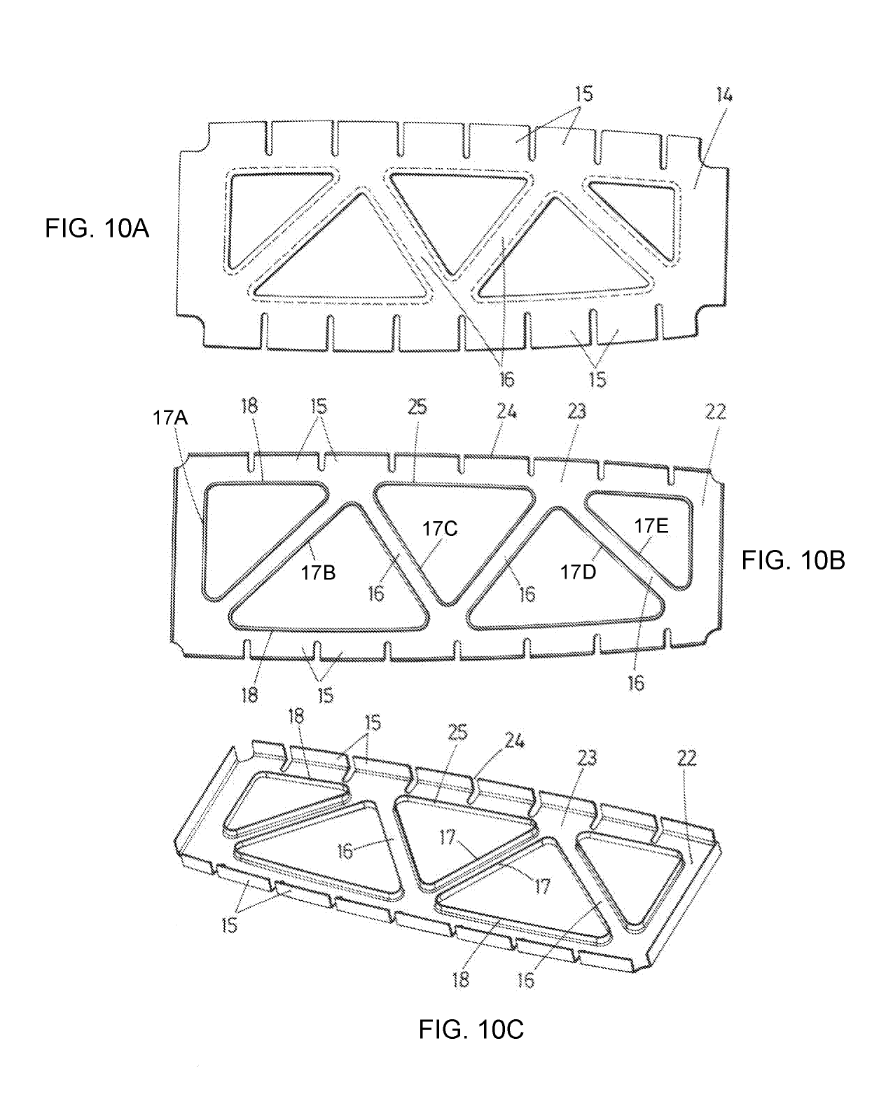

In the alternative example shown in FIG. 10, there are no cut-outs (26), and the flat flanges (17), instead of being individual straight segments, are formed as continuous flanges (17A, 17B, 17C, 17D, and 17E) with a triangular configuration, or any other suitable configuration as circular for example. The continuous flanges (17A, 17B, 17C, 17D, and 17E) are also folded in a press-forming process using proper conforming tooling. Since there are no cut-outs (26), the cutting process is simplified.

Based on specific rib loads and requirements for each particular application, thicknesses transitions, truss-shaped rib web geometrical arrangement, and internal flanges width can be optimized.

By predefining an internal configuration with standard shaped truss-lattice holes, this rib manufacturing process of the present disclosure could also allow interchangeable tooling parts, thus, reducing even more the manufacturing cost and time of a given aircraft ribs set.

Other preferred aspects of the present disclosure are described in the appended dependent claims and/or the multiple combinations thereof.

What is claimed:

1. A composite rib for a torsion box, comprising:
a unitary body formed by a single pre-formed stacked of a plurality of plies.

2. The composite rib according to claim 1, wherein the unitary body of the composite rib includes an outer frame having a substantially rectangular configuration with an outer frame contour and an internal frame contour, and wherein the outer frame contour has a plurality of flanges.

3. The composite rib according to claim 2, wherein the plurality of flanges are arranged such that the rib has one of a flat, C-shaped, and I-shaped cross-sectional shape.

4. The composite rib according to claim 2, wherein the unitary body of the composite rib further includes a plurality of diagonal trusses forming a zigzag pattern within an area defined by the internal frame contour, and
wherein the unitary body of the composite rib further includes at least one flange are at opposite sides of the trusses, and at least one flange formed at the internal frame contour.

5. The composite rib according to claim 4, wherein the at least one flange are at the opposite sides of the trusses are individual straight segments.

6. The composite rib according to claim 4, wherein the at least one flange are at opposite sides of the trusses are part of a continuous flange.

7. A method for manufacturing a composite rib for a torsion box, the method comprising the steps of:
laying up a plurality of plies of composite material to form a substantially flat stack of plies;
cutting the stack of plies to form a flat pre-form having an outer contour with a plurality of flanges, and an internal contour within an area defined by the outer contour, the internal contour having at least two trusses, and a plurality of flanges are at opposite sides of the trusses;
press-forming the flat pre-form to fold the plurality of flanges of the outer and internal contour to form the composite rib pre-form, and
curing the composite rib pre-form.

8. The method according to claim 7, wherein the internal contour has a plurality diagonal trusses forming a zigzag pattern, and a plurality of openings in the flat pre-form with a plurality of flanges in the sides of each opening.

9. The method according to claim 7, wherein the plurality of openings have one of a triangular and circular shape.

10. The method according to claim 7, wherein the outer contour is generally rectangular with two large opposing sides and two short opposing sides, and wherein the plurality of flanges are folded towards the same side of the rib such that the rib has a C-shaped cross-sectional shape.

11. The method according to any of the claims 7, wherein the plurality of plies are dry plies and the rib pre-form is cured in a Resin Transfer Molding (RTM) process.

12. The method according to any of the claims 7, wherein the plurality of plies are resin pre-impregnated plies.

13. The method according to claim 7, further comprising the step of:
forming two symmetrical C-shaped rib pre-forms;
arranging the two C-shaped rib pre-forms together as to form an I-shaped rib pre-forms, and
curing to the two C-shaped rib pre-forms together.
